(19) United States
(12) Patent Application Publication
(10) Pub. No.: US 2026/0321263 A1
(43) Pub. Date: Oct. 15, 2026

(54) Silent Speech Communication System Utilizing Piezoelectric Sensing and Neuromorphic Processing

(71) Applicant: William Paul McCreary, Dillsburg, PA (US)

(72) Inventor: William Paul McCreary, Dillsburg, PA (US)

(21) Appl. No.: 19/646,462

(22) Filed: Apr. 13, 2026

Related U.S. Application Data
(60) Provisional application No. 63/789,363, filed on Apr. 15, 2025.

(51) Int. Cl. G10L 15/24; G10L 15/06; G10L 15/07; G10L 15/30; G10L 21/0208; H04M 1/72409; H04W 76/10

(52) U.S. Cl. CPC G10L 15/24; G10L 15/063; G10L 15/07; G10L 15/30; G10L 21/0208; H04M 1/724094; H04W 76/10; H04M 2201/39

(57) ABSTRACT

A modular silent speech communication system is disclosed for detecting, decoding, and transmitting subvocal speech without audible vocalization. The system includes a wearable sensing and processing module and audio modules. The sensing module utilizes vibration sensors and inertial measurement units to capture physiological signals associated with speech articulation. Sensor data is processed using embedded artificial intelligence models configured for signal conditioning, feature extraction, and intent classification to generate linguistic outputs. The decoded information is wirelessly transmitted via an interface to the audio modules, which deliver sound through cranial bone conduction pathways. The system supports both individual and multi-user communication modes through a distributed wireless network enabling real-time silent group interaction and can be received by mobile devices. A cloud-based machine learning infrastructure provides continuous model optimization that improves accuracy, responsiveness, and overall system performance. Conversely, there is an offline mode where it can be independent of any cloud or internet.

### CROSS-REFERENCE TO RELATED APPLICATIONS

The present application includes subject matter disclosed in and claims priority to a provisional application entitled “Cognitive Enhancement Brain-Computer Interface Headband” filed on Apr. 15 2025 and assigned Application No. 63/789,363 describing an invention made by the present inventor.

### FIELD OF THE INVENTION

The present invention generally relates to the field of silent speech. More specifically, it relates to a silent speech communication system utilizing piezoelectric sensing and neuromorphic processing technology.

### BACKGROUND

Silent speech technologies have emerged as a promising frontier in human-computer interaction, enabling users to communicate without audible vocalization. These systems interpret user intent through non-vocal signals, offering applications in assistive communication, privacy-preserving interactions, and hands-free device control. Among the prevailing approaches, electromyography (EMG)-based systems and visual lip-reading techniques have garnered substantial attention. EMG methods typically employ surface electrodes to detect the electrical activity generated by muscle contractions involved in speech articulation. While EMG offers the advantage of being operable in low-light or noisy environments, its effectiveness is highly dependent on precise sensor placement, skin-electrode impedance, and the variability of muscle signals across users. As a result, EMG-based silent speech interfaces often suffer from inconsistent signal quality, limited generalizability, and susceptibility to motion artifacts, all of which can hinder their practical deployment and long-term usability. Visual lip-reading systems, on the other hand, attempt to interpret speech by analyzing lip movements using optical sensors or video cameras. These systems benefit from being non-invasive and intuitive for users; however, they also present notable challenges. Lip-reading accuracy can be significantly affected by external lighting conditions, occlusions (e.g., facial hair, masks, or head movement), and the intrinsic ambiguity of lip shapes that correspond to different phonemes—especially in the absence of contextual audio cues.

Additionally, current machine learning and computer vision techniques employed in visual lip-reading often require large training datasets and extensive computational resources to achieve acceptable performance, which may limit real-time responsiveness or portability in mobile applications. Furthermore, both EMG and visual lip-reading approaches typically lack the robustness required for naturalistic, continuous speech interaction in diverse real-world settings. User fatigue, the need for calibration, and the variability in speech articulation styles introduce further complexity and reduce the reliability of these systems over time. As such, despite considerable research efforts and technological advances, existing silent speech technologies remain constrained by limitations in sensitivity, accuracy, adaptability, and user convenience. These shortcomings underscore a critical need for alternative or hybrid silent speech recognition methods that can overcome the inherent challenges of current solutions while providing scalable, user-friendly, and high-fidelity interfaces suitable for a wide range of applications. What is needed is an apparatus that can improve the limitations in sensitivity, accuracy, and usability of current silent speech technology.

### SUMMARY OF THE INVENTION

The device herein disclosed and described provides a solution to the shortcomings in the prior art through the disclosure of a silent speech communication system utilizing piezoelectric sensing and neuromorphic technology. An object of this invention is to enhance the sensitivity and accuracy of silent speech between users. An object of the silent speech communication system is to enable a user to communicate without producing audible sound. For example, subvocal or pre-articulatory signals are detected and translated into meaningful outputs, allowing discreet communication in environments where speech is impractical or undesirable.

Another object is to improve the accuracy of silent speech detection through multi-modal sensing. For example, the combination of vibration sensors and inertial measurement units provides complementary data that enhances signal fidelity and reduces susceptibility to noise and misinterpretation.

Another object is to provide real-time decoding of speech and intent. For example, embedded artificial intelligence models process sensor data with minimal latency, allowing users to experience near-instantaneous communication without delays. The system can also outputs speech or text to a mobile device via app. The app can also convert speech to text or for a subscription fee, the app can access the cloud for enhanced speech conversion in the instance of an accent or speech impediment being detected. This feature also allows individuals to create a custom biological-based machine learning algorithms tailored to their individual speaking patterns.

Another object is to enable detection of pre-articulatory intent signals prior to full speech formation. For example, early-stage physiological signals are analyzed to anticipate user intent, thereby improving responsiveness and reducing communication lag.

Another object is to deliver audio feedback without obstructing the ear canal. For example, bone conduction transducers transmit sound through cranial pathways, allowing users to remain aware of environmental sounds while receiving communication.

Another object is to support private and discreet communication. For example, audio output is delivered directly to the user through bone conduction, preventing others from hearing the transmitted information.

Another object is to facilitate multi-user communication in a silent environment. For example, multiple devices can connect through a wireless network to enable real-time group discussions without audible speech.

Another object is to provide a modular system architecture. For example, separating sensing, processing, and output components into distinct modules allows for flexibility, scalability, and ease of maintenance or upgrades.

Another object is to reduce thermal load and improve wearability. For example, distributing processing and output functions across multiple modules prevents overheating in a single device and enhances user comfort.

Another object is to utilize low-power wireless communication for efficient data transfer. For example, Bluetooth Low Energy enables reliable communication between modules while minimizing energy consumption.

Another object is to support both individual and group communication modes. For example, a selectable interface allows users to switch between personal use and multi-user interaction depending on the application.

Another object is to enhance robustness against environmental and motion-related noise. For example, sensor fusion techniques combine multiple data streams to filter out irrelevant signals and improve decoding reliability.

Another object is to enable continuous learning and system improvement. For example, cloud-based machine learning infrastructure updates models over time to enhance accuracy and adapt to user-specific speech patterns.

Another object is to provide user-specific personalization. For example, the system learns from individual usage patterns and feedback to tailor decoding performance to each user.

Another object is to reduce dependence on precise sensor placement. For example, the use of non-contact vibration sensors and sensor fusion reduces sensitivity to positioning errors compared to traditional electromyography systems.

Another object is to eliminate reliance on optical sensing methods. For example, the system avoids the need for cameras, thereby removing dependencies on lighting conditions and addressing privacy concerns.

Another object is to provide a hands-free human-machine interface. For example, users can interact with computing systems or communicate with others without the need for manual input devices.

Another object is to ensure low-latency communication in real-time applications. For example, onboard AI processing eliminates the need for external computation, reducing delays in signal interpretation and output generation.

Another object is to enable operation across varying environmental conditions. For example, the system is designed to function reliably in different lighting, noise, and motion scenarios without degradation in performance.

Another object is to provide a compact and wearable form factor. For example, the neckband and ear modules are constructed from lightweight and flexible materials to ensure comfort during extended use.

Another object is to ensure durability and environmental resistance. For example, nano-coated printed circuit boards protect internal components from moisture, dust, and contaminants.

Another object is to provide reliable power management and extended operation time. For example, rechargeable batteries support multiple hours of continuous use with rapid recharge capability.

Another object is to reduce false activations and unintended outputs. For example, confidence thresholds and filtering algorithms suppress signals that do not meet predefined reliability criteria.

Another object is to distinguish between intentional speech and internal monologue. For example, pattern recognition techniques analyze signal characteristics to prevent unintended communication.

Another object is to support bi-directional sensing capabilities. For example, bone conduction modules may also detect cranial vibrations to provide additional input for processing.

Another object is to enable scalable communication networks. For example, peer-to-peer or distributed communication architectures allow multiple users to connect without centralized infrastructure.

Another object is to maintain communication integrity in multi-user environments. For example, synchronization and prioritization mechanisms ensure coherent and low-latency interactions among users.

Another object is to allow integration with external systems and platforms. For example, the modular design enables connectivity with other devices or applications to expand functionality.

Another object is to provide a safe and ergonomically optimized user experience. For example, flexible materials and low thermal output ensure comfort and prevent user fatigue during prolonged use.

Another object is to enhance accessibility for individuals with speech impairments. For example, the system enables communication through physiological signals rather than audible speech, broadening usability.

Another object is to provide secure communication in sensitive environments. For example, silent transmission reduces the risk of eavesdropping compared to traditional verbal communication.

Another object is to enable rapid deployment and ease of use. For example, simple power-on and automatic wireless pairing streamline the user experience without complex setup procedures.

Another object is to support future extensibility and technological evolution. For example, the system architecture allows incorporation of additional sensors, alternative communication protocols, and improved processing hardware without redesigning the entire system.

It is briefly noted that upon a reading this disclosure, those skilled in the art will recognize various means for carrying out these intended features of the invention. As such it is to be understood that other methods, applications and systems adapted to the task may be configured to carry out these features and are therefore considered to be within the scope and intent of the present invention, and are anticipated. With respect to the above description, before explaining at least one preferred embodiment of the herein disclosed invention in detail, it is to be understood that the invention is not limited in its application to the details of construction and to the arrangement of the components in the following description or illustrated in the drawings. The invention herein described is capable of other embodiments and of being practiced and carried out in various ways which will be obvious to those skilled in the art. Also, it is to be understood that the phraseology and terminology employed herein are the purpose of description and should not be regarded as limiting.

As such, those skilled in the art will appreciate that the conception upon which this disclosure is based may readily be utilized as a basis for designing of other structures, methods and systems for carrying out the several purposes of the present disclosed device. It is important, therefore, that the claims be regarded as including such equivalent construction and methodology insofar as they do not depart from the spirit and scope of the present invention. As used in the claims to describe the various inventive aspects and embodiments, “comprising” means including, but not limited to, whatever follows the word “comprising”. Thus, use of the term “comprising” indicates that the listed elements are required or mandatory, but that other elements are optional and may or may not be present. By “consisting of” is meant including, and limited to, whatever follows the phrase “consisting of”. Thus, the phrase “consisting of” indicates that the listed elements are required or mandatory, and that no other elements may be present.

By “consisting essentially of” is meant including any elements listed after the phrase, and limited to other elements that do not interfere with or contribute to the activity or action specified in the disclosure for the listed elements. Thus, the phrase “consisting essentially of” indicates that the listed elements are required or mandatory, but that other elements are optional and may or may not be present depending upon whether or not they affect the activity or action of the listed elements. The objects features, and advantages of the present invention, as well as the advantages thereof over existing prior art, which will become apparent from the description to follow, are accomplished by the improvements described in this specification and hereinafter described in the following detailed description which fully discloses the invention, but should not be considered as placing limitations thereon.

### BRIEF DESCRIPTION OF THE FIGURES

The accompanying drawings, which are incorporated herein and form a part of the specification, illustrate some, but not the only or exclusive, examples of embodiments and/or features.

FIG. 1 shows a perspective view of the system being used.

FIG. 2 shows various closeup views of the system.

FIG. 3 shows components of sending and processing and audio output modules.

FIG. 4 shows the method steps in detail.

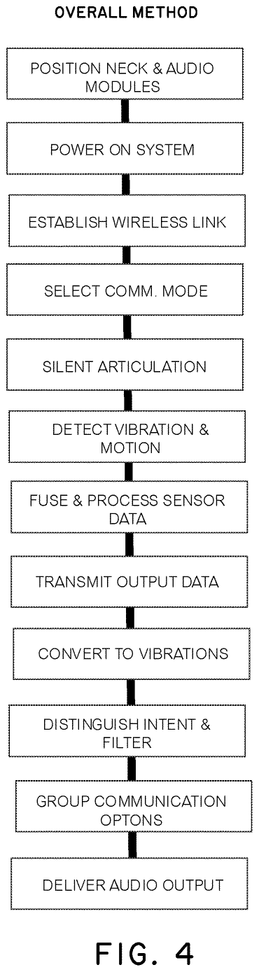

FIG. 5 shows general schematics.

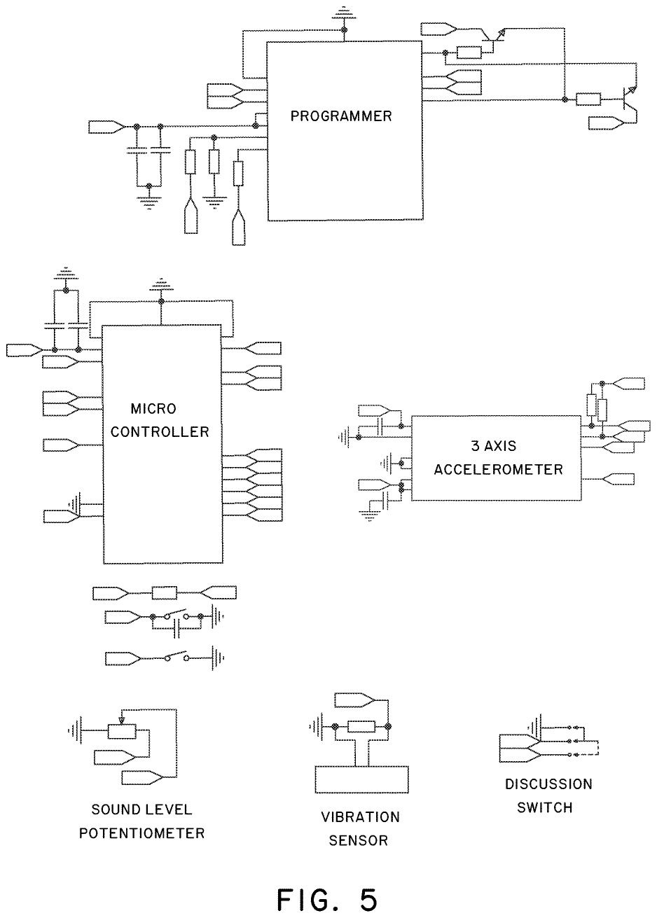

FIG. 6 shows general schematics.

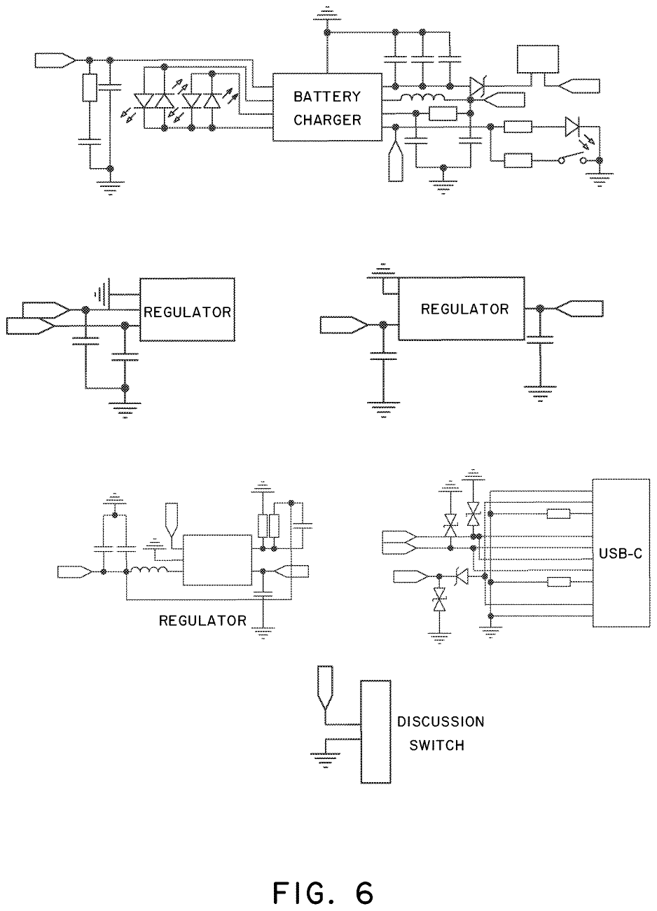

FIG. 7 shows general schematics.

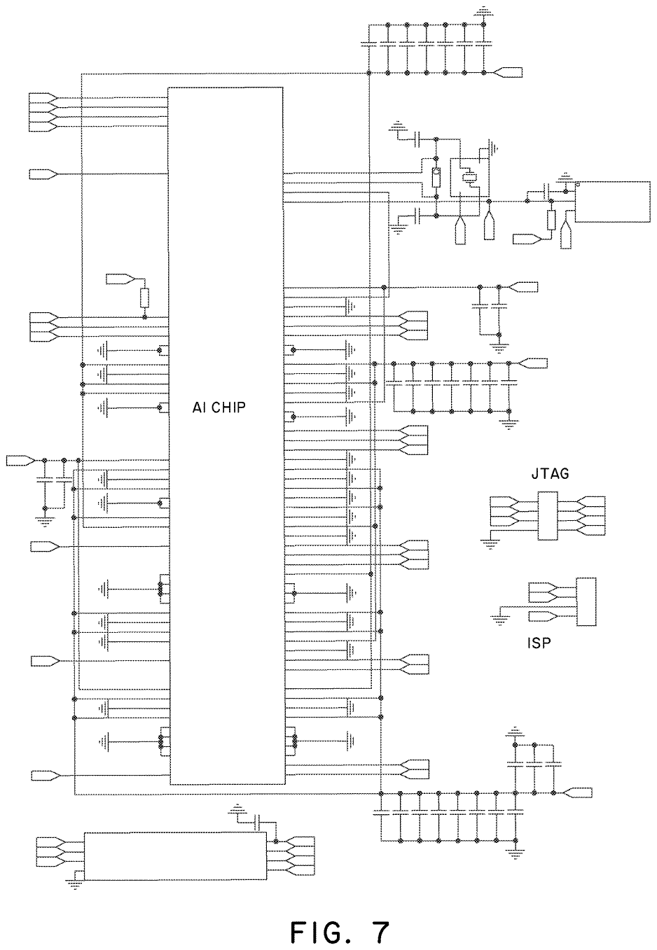

Other aspects of the present invention shall be more readily understood when considered in conjunction with the accompanying drawings, and the following detailed description, neither of which should be considered limiting.

### DETAILED DESCRIPTION OF FIGURES

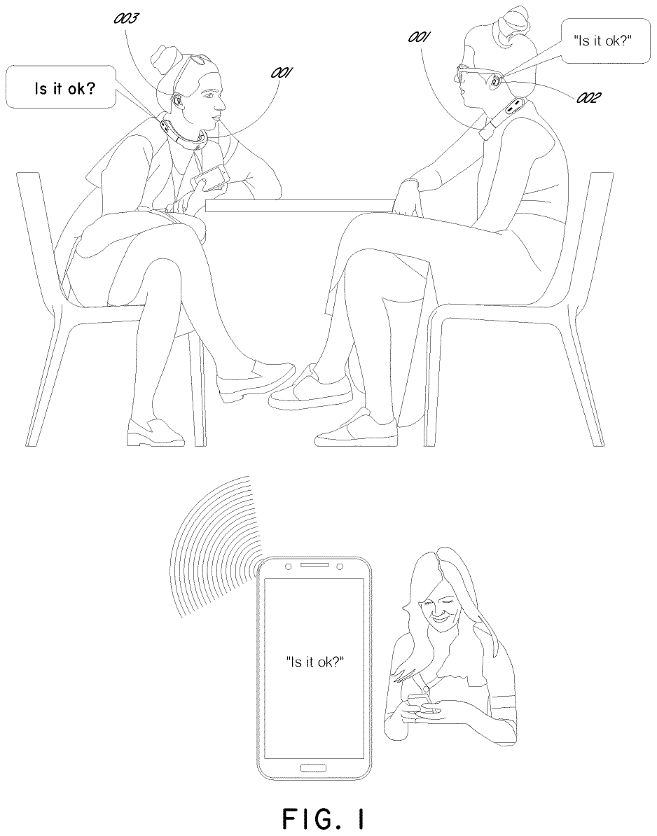

In this description, terms such as up, upward, down, downward, front, back, top, upper, bottom, lower, left, right, and similar directional references pertain to the orientation of the device as shown in the accompanying drawings. These terms are provided for ease of understanding and are not meant to restrict or dictate the device's specific orientation or method of use. Additionally, standard components of the invention, which are already well-established in the prior art, will not be described in detail within this disclosure. The present invention relates to a silent speech communication system configured to detect, interpret, and reproduce speech-related intent without requiring audible vocalization that relies on a non-transitory computer-readable medium storing and executing instructions. The system is depicted in FIG. s 1 and 2 may include a distributed arrangement of wearable modules that cooperate to acquire physiological signals, process those signals into meaningful linguistic or intent-based outputs, and deliver feedback to a user through non-obstructive auditory pathways. FIG. 1 showing an embodiment whereby outputs are converted and transferred wirelessly to a computing device including but not limited to a mobile device app and the like by means of wireless transmitters therein. In one embodiment, the system may include a sensing and processing module 001 positioned proximate to a user's neck region, and one or more audio output modules (worn on the left being 002 and the right being 003) positioned adjacent to the user's ears. The sensing and processing module 001 may include one or more vibration sensing elements configured to detect micro-mechanical oscillations generated by anatomical structures associated with speech articulation, including but not limited to the larynx, vocal folds, surrounding musculature, and connective tissues. The sensing and processing module may further include motion sensing elements configured to detect movement, orientation, and dynamic activity of the neck and jaw region, which may include but not be limited to accelerometers, gyroscopes, magnetometers, or other inertial sensing technologies.

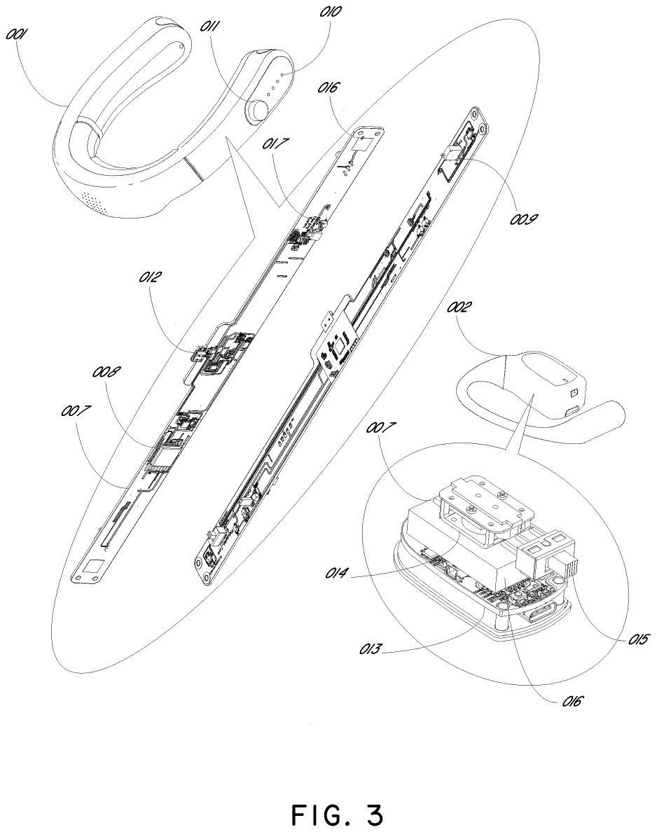

The system may include a processing architecture for both the sensing and processing module 001 and audio output modules 002 and 003 that can include one or more microcontrollers 007 (as seen in FIG. 3), digital signal processors 008, neural processing units 009, or other computational hardware configured to perform real-time signal conditioning, feature extraction, temporal analysis, and classification. Such processing may include, but is not limited to, filtering, amplification, noise reduction, and normalization of sensor signals prior to higher-level interpretation. The system may further include machine learning models that may include, but are not limited to, convolutional neural networks, recurrent neural networks, transformer-based architectures, or hybrid models trained to identify phonetic patterns, linguistic structures, and user intent from physiological signals. These models may be executed locally on embedded hardware or may include distributed processing between edge devices and remote computing infrastructure. The sensing and processing module 001 may include LED status indicators 010 and volume control 011 thereon.

In certain embodiments, the system may include multi-modal sensor fusion, wherein signals from multiple sensing elements 012 are combined to generate a composite representation of speech-related activity. This fusion process may include probabilistic modeling, weighted signal integration, or adaptive filtering techniques that improve robustness against noise, motion artifacts, and variability in sensor placement. The system may further include adaptive calibration mechanisms that continuously adjust model parameters based on user-specific characteristics, including but not limited to anatomical differences, speech habits, and environmental conditions.

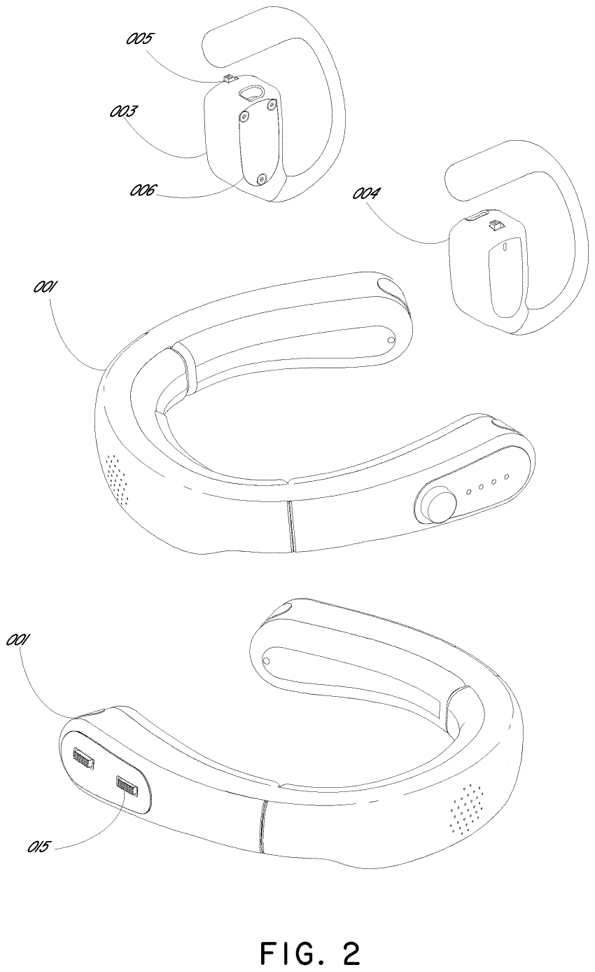

The audio output modules 002 and 003 may include bone conduction transducers 006 shown in FIG. 2, configured to convert electrical signals into mechanical vibrations that are transmitted through cranial structures to the inner ear. These modules may include, but are not limited to, piezoelectric actuators 013, electromagnetic drivers, or micro-electromechanical systems (configured for efficient vibration transfer) onboard AI chips, USB-C connection ports. Said AI chip using a non-transitory computer-readable medium storing instructions that, when executed by one or more processing units cause the system to perform operations including silent speech communication. The use of bone conduction may allow the user to perceive audio without occluding the ear canal, thereby maintaining situational awareness. In some embodiments, the audio output modules 002 and 003 may further include sensing capabilities configured to detect cranial vibrations, thereby enabling bi-directional signal acquisition and enhanced processing fidelity. The system may include a wireless communication interface 014 that can include, but is not limited to, short-range communication technologies, ultra-wideband systems, mesh networking protocols, or other low-power communication methods configured to transmit data between modules and among multiple devices. In multi-user embodiments, the system may establish a communication network that enables real-time exchange of decoded speech among users. Such a network may include peer-to-peer configurations, hub-based architectures, or distributed coordination mechanisms that manage data synchronization, transmission prioritization, and latency reduction.

The invention may further include integration with cloud-based or remote computing infrastructure that can include, but is not limited to, data storage systems, model training environments, and update distribution mechanisms. This infrastructure may be configured to receive anonymized or user-consented data, perform model refinement, and deploy updated parameters back to user devices. Another embodiment includes having an offline mode that allows operations to take place independent of any cloud network or internet. The system may include privacy-preserving techniques such as encryption, differential privacy, or federated learning to ensure secure handling of user data. From a physical implementation perspective, the system may include a wearable form factor constructed from flexible and lightweight materials that conform to a user's anatomy. The sensing module may include ergonomic features that ensure consistent contact with the skin, while the audio modules may include adjustable or adaptive mounting structures for comfort and stability. The system may include power management components 015 that can include rechargeable battery systems 016, energy harvesting mechanisms, or efficient voltage regulation circuits 017 designed to support extended operation with minimal downtime. General schematics for the programmer, accelerometer, micro controller, sound level potentiometer, vibration sensor, discussion switch, regulators, battery charger, USB-C, JTAG, ISP and the onboard AI chip are presented in FIG. s 5-7.

In operation, the method may include but is not limited to several steps. A user first positions the sensing module around the neck such that the sensing elements are aligned with anatomical regions associated with speech production. The user may then position the audio output modules adjacent to the ears. Upon activation, the system may establish communication between modules and initialize processing routines. The user may then engage in silent articulation by moving the mouth, tongue, and associated musculature without producing audible sound. During this process, the sensing elements may detect vibration and motion signals, which are then transmitted to the processing unit. The processing unit may perform signal conditioning, followed by feature extraction and classification using trained models. The system may identify phonetic components, words, phrases, or higher-level intent representations from the acquired data. In certain embodiments, the system may detect pre-articulatory signals, enabling prediction of user intent prior to full articulation. The decoded output may then be transmitted to the audio modules, which convert the signal into vibrations perceivable by the user. In multi-user configurations, the decoded output may also be transmitted to other connected devices, enabling silent communication among multiple users.

The method of using the invention may include the steps of positioning the sensing module, activating the system, selecting a communication mode, performing silent articulation, processing the acquired signals, generating decoded outputs, and delivering feedback through bone conduction. The method may further include steps performed by the system, including continuous monitoring of sensor data, adaptive filtering, confidence evaluation, suppression of low-confidence outputs, and updating of model parameters based on user interaction. Various embodiments of the invention may include alternative sensing technologies, including but not limited to acoustic sensors, pressure sensors, capacitive sensors, optical sensors configured for internal tissue monitoring, or bioimpedance measurement systems. Additional embodiments may include integration with external devices such as mobile computing platforms, augmented reality systems, or assistive technologies. The system may also be configured to interpret non-linguistic signals, enabling control of external devices or execution of commands based on detected intent.

In addressing considerations related to patent eligibility, the invention is directed to a practical application of technology that integrates specific hardware components and processing techniques to transform physiological signals into a tangible and useful result, namely, the generation and transmission of decoded speech. The system does not merely perform abstract data processing but instead applies machine learning models in conjunction with specialized sensing hardware and communication systems to achieve a concrete technological improvement in human-machine interaction and communication capability. The claimed subject matter therefore represents a specific and technical solution to a recognized problem in the field and is not directed to an abstract idea without additional inventive concepts.

It is additionally noted and anticipated that although the device is shown in its most simple form, various components and aspects of the device may be differently shaped or slightly modified when forming the invention herein. As such those skilled in the art will appreciate the descriptions and depictions set forth in this disclosure or merely meant to portray examples of preferred modes within the overall scope and intent of the invention, and are not to be considered limiting in any manner. While all of the fundamental characteristics and features of the invention have been shown and described herein, with reference to particular embodiments thereof, a latitude of modification, various changes and substitutions are intended in the foregoing disclosure and it will be apparent that in some instances, some features of the invention may be employed without a corresponding use of other features without departing from the scope of the invention as set forth. It should also be understood that various substitutions, modifications, and variations may be made by those skilled in the art without departing from the scope of the invention.

What is claimed is:

1. A silent speech communication system comprising:
a) a first module configured to be worn in proximity to a neck region of a user;
b) at least one vibration sensing element included in the first module and configured to detect mechanical micro-vibrations generated by anatomical structures associated with speech articulation;
c) at least one inertial measurement sensor included in the first module and configured to detect motion, orientation, and dynamic muscular activity associated with speech-related movements;
d) a processing unit operatively coupled to the at least one vibration sensing element and the at least one inertial measurement sensor;
e) wherein the processing unit is configured to perform signal conditioning, feature extraction, pattern recognition, and classification using one or more artificial intelligence models to decode detected signals into linguistic outputs or intent-based representations;
f) wherein the processing unit is further configured to perform multi-modal sensor fusion by combining signals obtained from the at least one vibration sensing element and the at least one inertial measurement sensor to generate a composite signal representation that enhances robustness against noise, motion artifacts, and variations in sensor placement;
g) a wireless communication interface operatively coupled to the processing unit and configured to transmit the decoded output using a low-power communication protocol;
h) at least two additional modules configured as wearable audio output devices positioned adjacent to left and right ears of the user;
i) wherein each of the at least two additional modules includes a receiver configured to accept transmitted data and a bone conduction transducer configured to convert received data into mechanical vibrations deliverable to an auditory system of the user through cranial pathways;
j) wherein the system is configured to enable real-time communication of silent or subvocal speech without requiring audible vocalization and to establish connectivity with one or more additional silent speech communication systems to form a multi-user communication network enabling simultaneous silent communication among multiple users within a shared communication environment; and
k) wireless transmitters that can send outputs to computing devices.

2. A method of silent speech communication using a non-transitory computer-readable medium storing instructions that, when executed by one or more processing units associated with a wearable silent speech communication system, cause the system to perform operations comprising:
a) positioning a sensing module in proximity to a neck region of a user;
b) positioning at least two audio output modules adjacent to left and right ears of the user;
c) detecting, via at least one vibration sensing element, mechanical micro-vibrations generated during silent or subvocal articulation;
d) detecting, via at least one inertial measurement sensor, motion and dynamic muscular activity associated with speech-related movements;
e) combining the detected signals using multi-modal sensor fusion to generate a composite signal representation;
f) processing the composite signal representation using one or more artificial intelligence models to perform signal conditioning, feature extraction, pattern recognition, and classification to decode the signals into linguistic outputs or intent-based representations;
g) detecting pre-articulatory intent signals prior to full speech formation to reduce latency;
h) transmitting the decoded output via a wireless communication interface using a low-power communication protocol to the at least two audio output modules;
i) converting the transmitted decoded output into mechanical vibrations using bone conduction transducers;
j) delivering the mechanical vibrations to an auditory system of the user through cranial pathways;
k) suppressing unintended outputs based on confidence thresholds and pattern recognition techniques to distinguish between intentional speech signals and internal monologue;
l) establishing a communication network among multiple devices to enable real-time silent group communication; and
m) updating artificial intelligence model parameters based on user-specific patterns to improve decoding accuracy and responsiveness over time. The system of claim 1, wherein the processing unit is further configured to detect pre-articulatory intent by identifying early-stage physiological signal patterns occurring prior to full phoneme formation.

3. The system of claim 1, wherein the wireless communication interface is configured to support both point-to-point communication between modules and multi-device communication for group discussion.

4. The system of claim 1, wherein the processing unit is further configured to determine a confidence level associated with decoded outputs and to suppress, delay, or modify output generation when the confidence level falls below a predefined threshold.

5. The system of claim 1, wherein at least one of the audio output modules is configured to operate in a bi-directional mode to detect cranial vibration signals and provide additional input signals for processing.

6. The system of claim 1, wherein the processing unit is configured to distinguish between intentional speech signals and unintended subvocal activity based on signal duration, intensity, and pattern recognition.

7. The system of claim 1, wherein the first module and the at least two additional modules are configured as independent and detachable components allowing replacement, upgrading, or reconfiguration without affecting overall system functionality.

8. The system of claim 1, wherein the system is configured to operate with low latency such that detection, decoding, transmission, and output generation occur substantially in real time.

9. The system of claim 1, wherein the artificial intelligence models are configured to adapt to user-specific speech patterns by incorporating feedback obtained during system operation.

10. The method of claim 2, wherein combining the detected signals includes integrating vibration and motion data to enhance robustness against environmental noise and motion artifacts.

12. The method of claim 2, wherein processing the composite signal representation includes identifying phonetic structures, words, phrases, or higher-level intent classifications.

13. The method of claim 2, further comprising establishing a peer-to-peer or distributed communication network to transmit decoded outputs among multiple users.

14. The method of claim 2, further comprising continuously monitoring sensor data and performing adaptive filtering to improve signal fidelity.

15. The method of claim 2, further comprising updating model parameters using cloud-based infrastructure to enable continuous learning and user-specific personalization.

16. The system of claim 1, further comprising an embodiment having an offline mode that allows operations to take place independent of any cloud network or internet.

17. The system of claim 1, wherein the app also converts speech to text or for a subscription fee, that access the cloud for enhanced speech conversion in the instance of an accent or speech impediment being detected and also allows individuals to create a custom biological-based machine learning algorithms tailored to their individual speaking patterns.
